(19) United States
(12) Patent Application Publication
(10) Pub. No.: US 2021/0117165 A1
(43) Pub. Date: Apr. 22, 2021

(54) CLOUD-BASED APPLICATION DEVELOPMENT AND CONFIGURATION

(71) Applicant: SAP SE, Walldorf (DE)

(72) Inventor: STEPHANIE STANG, Muhlhausen (DE)

(21) Appl. No.: 16/657,001

(22) Filed: Oct. 18, 2019

(51) Int. Cl. G06F 8/36; G06F 8/71

(52) U.S. Cl. CPC G06F 8/36; G06F 8/71

(57) ABSTRACT

Disclosed herein are system, method, and computer program product embodiments for providing cloud-based application development and configuration functionality. An embodiment operates by determining that a shell of an application is configured to communicate over a cloud platform with a plurality of backend servers. A first configuration of the communications for a first implementation of the shell of the application is received, wherein the first configuration is different from a second configuration for a second implementation of the shell. The communications between the shell and one of the plurality of backend servers based on the first configuration. The first implementation of the shell of the application is generated based on the first configuration and modified communications, wherein the generated first implementation is operable on a mobile device.

### BACKGROUND

Developing an application, such an app for a mobile phone, is often a resource, money, and time intensive endeavor. Despite all of the effort put into creating apps, few apps actually make money especially when accounting for the time, money, and resources put into developing the app. Many of these independently created apps have similar functionalities or connect to similar backend systems, and yet each organization creating an app pays and invests its own resources to develop apps with overlapping functionality and communications.

### BRIEF DESCRIPTION OF THE DRAWINGS

The accompanying drawings are incorporated herein and form a part of the specification.

FIG. 1 is a block diagram 100 illustrating example functionality for providing a cloud-based application development and configuration system (CADC), according to some embodiments.

FIG. 2 is a block diagram illustrating example functionality for providing a cloud-based application development and configuration system (CADC), according to some embodiments.

FIG. 3 is a flowchart illustrating example operations of a system for providing cloud-based application development and configuration functionality, according to some embodiments.

FIG. 4 is example computer system useful for implementing various embodiments.

FIG. 5 is an example interface for configuring a cloud-based application, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a cloud-based application development and configuration system.

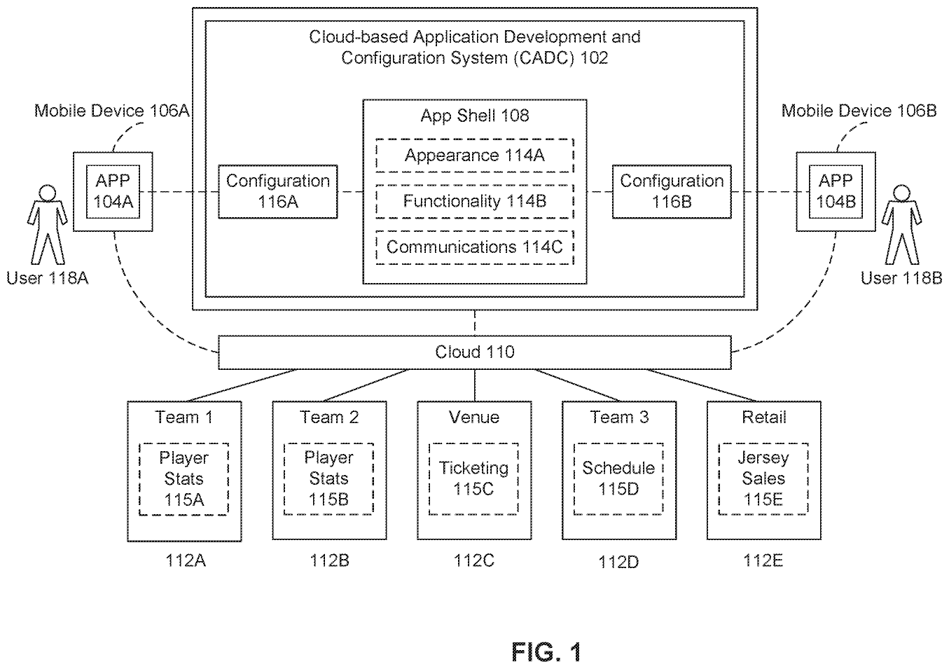

FIG. 1 is a block diagram 100 illustrating example functionality for providing a cloud-based application development and configuration system (CADC) 102, according to some embodiments.

Apps 104 are applications or programs that are designed to operate on mobile devices 106. Apps 104 often require Internet or network connectivity to perform at least a portion of the functionality of the app, including data synchronization. However, building an app is often a time, money, and resource intensive process that requires lots of computing resources. For example, when a company or organization wants to build an app, it has to have people to design the interface, build networking connections and backend functionality, program the app, test the app, compile the app, deploy the app, and then maintain the app performing bug fixes, upgrades, and improvements.

These same steps are followed over and over again by different organizations, despite the fact that many apps across different organizations may include the same or similar functionality. This traditional model of app building, of independently building apps with similar functionalities on an app-by-app basis, building is a waste of resources for all of the organizations involved in the app building.

CADC 102 removes many of these redundancies, simplifies, and streamlines the app building and configuration process across a group of companies or organizations who want to have apps 104 with similar or overlapping functionalities. These organizations may be members of a larger entity or organization, or have similar, shared, or complementary interests, pursuits, or goals.

For example, sports leagues such as a soccer league may include twelve teams that play across different stadiums. Each team and/or stadium where the teams play may want to have its own app 104 for reaching and interacting with their customers or users 118. Using the traditional model, each team of the league may independently design and produce its own app, however each app will then cost each team a great deal of money and resources.

Many of these apps will include identical, similar, or overlapping functionality. For example, each team may want to post its own team's data (such as images, player states, records, schedule, trophies, etc.) on its own app and sell its merchandise. And if two teams are playing each other a particular weekend, then both teams would want to have access to the stadium backend system so that the teams can sell tickets to the game through their respective apps.

Rather than requiring each team or organization to independently incur the costs of what developing identical functionality, CADC 102 eliminates many of these redundancies, and shortens the app development and configuration cycle through providing an app shell 108 that can be used by the various organizations of the league, including the teams and/or stadiums. The app shell 108 may include or be configurable to include functionality that is shared between two or more of the teams, such as ticketing, jersey sales, loyalty rewards programs, and pushing and pulling data through each team's respective app 104. The sports league may then share the initial shell development costs amongst the teams or organizations of the league.

By basing their app off a shared app shell 108 (hereinafter referred to as shell 108), each team may then configure and personalize the appearance 114A, functionality 114B, and communications 114C to suit the particular team's needs. Shell 108 of CADC 102 may be used by any group of related individuals, companies, or organizations that include an overlap in the functionalities they want to include in their respective apps and/or backend systems with which the apps need to be configured to communicate. Examples of such relationships between organizations and individuals may include a mall with various stores, a sports league with various teams, airports, hospitals, a television, broadcasting, or streaming network with various channels or shows, and other corporate organizations.

However, the primary example provided herein as an example embodiment will be with regard to a soccer league that includes member teams, which of which require their own customized app 104. The apps 104 for the various teams each include overlapping functionality 114B or communications 114C that is shared with at least one other team app 104 which was pre-configured through shell 108. As noted above, CADC 102 may also be applied in other contexts as well. For example, an app shell 108 for a shopping mall with a variety of stores, may be used and configured across different shopping malls or other shopping complexes that include overlapping functionality 114B and/or access to one or more similar backend systems 112.

Shell 108 may be a program or set of modules that include one or more sets of pre-configured functionalities 114B and/or communications channels 114C. The functionalities 114B may be operations performed with regard to receiving, retrieving, or transforming data responsive to user requests and/or computing prompts. The communications 114C may include communication channels that have been preconfigured or set up between app shell 108 and one or more other devices or backend systems 112. In an embodiment, different portions or modules of app shell 108 may be selectable or configurable by participating organizations or clients, to suit their particular needs. In an embodiment, one or more portions of shell 108 may be pre-compiled so that an organization utilizing the compiled functionality does not need to re-compile the pre-compiled portion to use it in the organization's app implementation 104.

In an embodiment, shell 108 may be configured to communicate over a cloud 110 with various computing devices, databases, or backend servers 112. Cloud 110 may be a cloud-based communications system that enables connectivity and communications (e.g., data transfer/exchange) between different devices with different operating systems, databases, and or other data formats.

Through cloud 110, shell 108 may be configured to communicate with a wide variety of different backend systems or servers 112. Backend systems or servers 112 may include any computing devices that are configured to provide a specific set of functionality or data to or through one or more websites and/or apps 104. In an embodiment, the different backend servers 112 may include different operating systems and databases, spread across various machines that operate independently or interdependently with one another. Each backend server 112 illustrated may include a cluster of multiple machines arranged in its own network or cloud system.

In an embodiment, the example soccer league may use the same or different shell 108 to provide an app for the various stadiums or venues where the matches are to be played as is used for the member or participating teams. The soccer league may include any different number of teams and multiple venues (of which only three teams and one venue are illustrated for the examples of FIG. 1). In another embodiment, the teams may be parts of different leagues, however may utilize the CADC 102 functionality as described herein if there an overlap in the functionalities 114B and/or communications 114C (e.g., backend servers 112) between the apps of the different teams.

Rather than requiring each team of the league to build out its own independent app, and incur all of the costs necessary to independently build its app, the league may build a shell 108 for the apps for the particular teams (and/or venues) that may be provided and customized or configured through CADC 102 to suit each team's particular needs.

In an embodiment, shell 108 may be pre-configured by application developers to communicate with the various backend systems 112 illustrated, before it is customized by the teams, organizations, or individuals using shell 108 to develop their own app 104. For example, a single shell 108 that is going to be used for the various teams may be configured to communicate with the various team backend systems or databases 112A, 112B, 112D, the various venues or stadium backend systems or apps 112C where the teams are scheduled to play, and a retail shop or league website 112E where fans can purchase jerseys or other equipment and merchandise specific to a particular team, player, the league, or the sport. In other embodiments, shell 108 may be configured or configurable to communicate with backend systems 112 other than those illustrated. These various communication interfaces may be configured as shell communications 114C.

In an embodiment, shell 108 may be preconfigured with functionality 114B that is requested by or likely to be shared by at least two or more teams or member organizations sharing or building their apps off of a common shell 108. Example functionality 114B may include the ability to sell venue tickets directly through a team's app, the ability to sell team-only merchandise through the team's app, the ability to conduct marketing campaigns and promotions through the team's app, and the ability to push and receive data through the app.

In an embodiment, functionality 114B and communications 114C may work and/or be configured together. For example, if a team decides it does not need to sell tickets (115C) through its app for a particular venue (112C), then the communications pathway to the venue backend system 112C may be disabled for that particular team app through shell 108 (which may allow the toggling on/off of various pre-configured functionalities 114B and communications 114C). This disabling of no longer necessary communications 114C may provide an extra layer of security, such that a hacker could not use the team's app 104 to access the backend system of a particular venue 112C.

In an embodiment, shell 10 may include a configurable default appearance 114A. Each team may alter, configure, or customize the appearance 114A of its app 104 using an interface builder application. For example, the teams may modify the logo, layout, text, colors, images, functionality, media, and other visible features of the various pages or screens of an app 104.

In an embodiment, through modifying appearance 114A, one team may include ticketing functionality 115C on the top of the first page or interface of its app, while a second team provides the purchase ticket functionality 115C as a menu selection or banner ad on different app interface page.

In an embodiment, various display elements may be tied functionality 114B. For example, buying tickets 115C may be performed through a menu option, a button, a banner, or other display element of appearance 114A in various implementations of app shell 108. In an embodiment, a team may also be able to configure the color scheme and logo that appears on the purchase tickets interface of app through appearance 114A to match the logo and color scheme of the team. Example functionalities 114B available through the various backend systems 112 are illustrated in boxes 115A-115E and include providing player statistics, ticketing, accessing schedule and team/record information, and jersey or merchandise sales.

As described above, CADC 102 may enable each team to modify the various options or features (appearance 114A, functionality 114B, and communications 114C) of shell 108 to configure, customize, develop, and generate its own implementation of shell 108 as app 104. These modifications, customizations, additions, removals, toggles, or selections of options may be stored as configurations 116. While the configurations 116 may be developer modified and may reference or include previously compiled features, the configurations 116 (including the previously compiled features) may be compiled together into functional or deployable apps 104A, 104B (or updates to previously released apps 104) that are executable across various mobile devices 106 with varying mobile operating systems.

As an example, Team 1 may be playing Team 2 at a particular venue on the upcoming weekend, while Team 3 may have the weekend off or may be playing another team at a different venue (not illustrated). Each of the teams may want to have their own apps to communicate with their fans, sell tickets, sell merchandise, and provide other fan-based services. Normally, each team would have to independently develop its own app to perform all of the same services, even though most of the apps include the same or overlapping functionality.

In another embodiment, app shell 108 may configured for hospital apps. Configuration 116A may then include customizations of the shell 108 as applicable to a first hospital, and configuration 116B may include customizations of the shell 108 as applicable to a second hospital. In an embodiment, the hospitals may be part of different hospital groups but both communicate with a backend pharmacy system (e.g., 112).

CADC 102 may provide an alternative to the independent app creation process through providing shell 108. Shell 108 may have been preconfigured by developers to communicate with Team 1 backend system 112A, Team 2 backend system 112B, venue backend system 112C, Team 3 backend system 112D, and a league retail store backend system 112E because these may be the various systems to which the various team apps may need to communicate.

When Team 1 and Team 2 want to set up their individual apps 104A and 104B, both teams may begin with shell 108. Team 1 may configure access to backend 112A for Team 1 through cloud 110. Access to backend 112A may require usernames, passwords, or other authentication. In an embodiment, shell 108 may be configured to be provided authentication access to read and/or write data to backend system 112A. For team 1, access to systems 112B and 112D may be disabled or prohibited, or Team 1 may be granted read-only access if Team 1 wants to read and use data from either system 112B or 112D in their app 104—which may require authorization from the respective parties or other authentication information. These communications configuration options 114C may be stored as part of configuration 116A for Team 1 and access to the backend systems 112 may be provided through one or more cloud 110 devices.

Team 1 may also or alternatively configure functionality 114B to select which functionalities 115A-E Team 1 available via shell 108 wants accessible via its app. For example, Team 1 may select the ticketing functionality 115D, and CADC 102 may enable, connect, or not disable (if already enabled) the communications 114C between shell 108 and system 112C.

Team 1 may also configure the appearance 114A, entering the team name, uploading the team logo, and selecting or customizing the color scheme for the interface of the app. These options may be saved as part of configuration 116A. When Team 1 is done selecting the various options, including adding new functionalities 114B or communications 114C, that may not have been part of the shared design elements of shell 108, these configurations 116A may be compiled using shell 108 to generate an executable app 104A.

Team 2 may also simultaneously configure its own app 104B using shell 108 based on its own requirements following a similar process, which may be saved as configuration 116B. CADC 102 may then compile configuration 116B into an executable app 104B for Team 2.

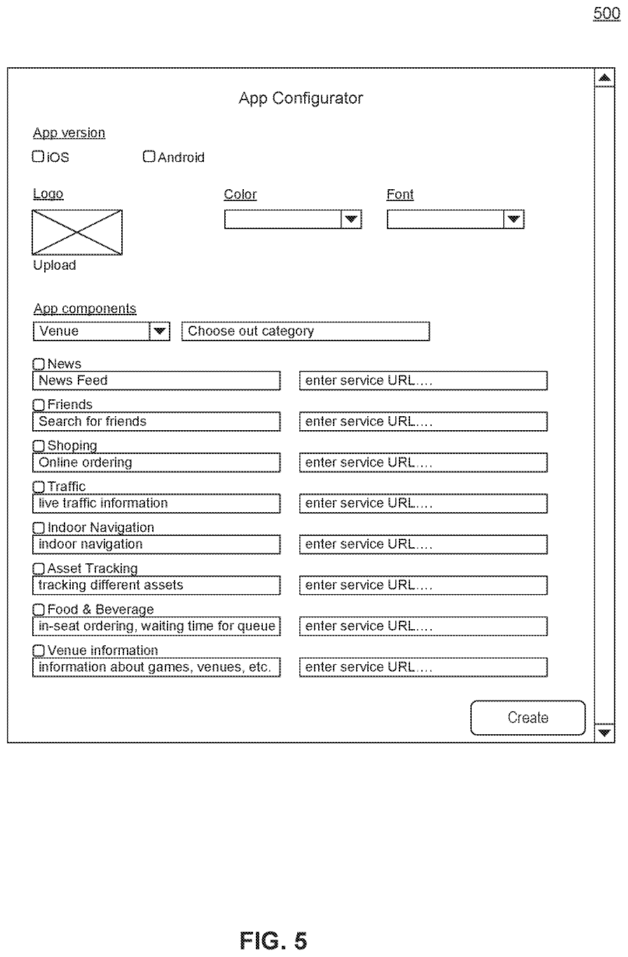

FIG. 5 is an example interface 500 for configuring a cloud-based application, according to some embodiments. Using the interface 500, shell 108 may be configured with a particular configuration 116 for an end user or client (e.g., Team). As illustrated in interface 500, an administrator or developer may select with operating platform or version of the app or shell is being configured iOS or ANDRIOD.

A logo can be uploaded, and a background color and font color may be selected. In an embodiment, the administrator may select which backend systems or functionality they want included in the configuration 116 for an app of shell 108. For example, shell 108 may be configured with News, Friends, Shopping, Traffic, Indoor Navigation, Asset Tracking, Food & Beverage, and Venue Information functionality. However not all of this functionality may be required for each embodiment of an app developed from shell 108.

Configuration interface 500 may enable a user or administrator to select which functionality is desired. As illustrated in the example of FIG. 5, in an embodiment, an administrator may select or enter a service URL (universal resource locator) with a network address related to providing that functionality.

Returning to FIG. 1, user 118A may be accessing the app 104A for Team 1. App shell 108 may be customized as configuration 116A, which is then compiled and shared across multiple different users 118A who have access to or who have downloaded app 104A. Similarly, user 118B may be accessing the app 104B for Team 2. App shell 108 may be customized as configuration 116B, which is then compiled and shared across multiple different users 118B who have access to or who have downloaded app 104B. In an embodiment, both apps 104A, 104b may simultaneously be provided or have access to the retail backend system 112E, while only app 104A has access to the team 1 backend system 112A, and only team 2 has access to the team 2 backend system 112B.

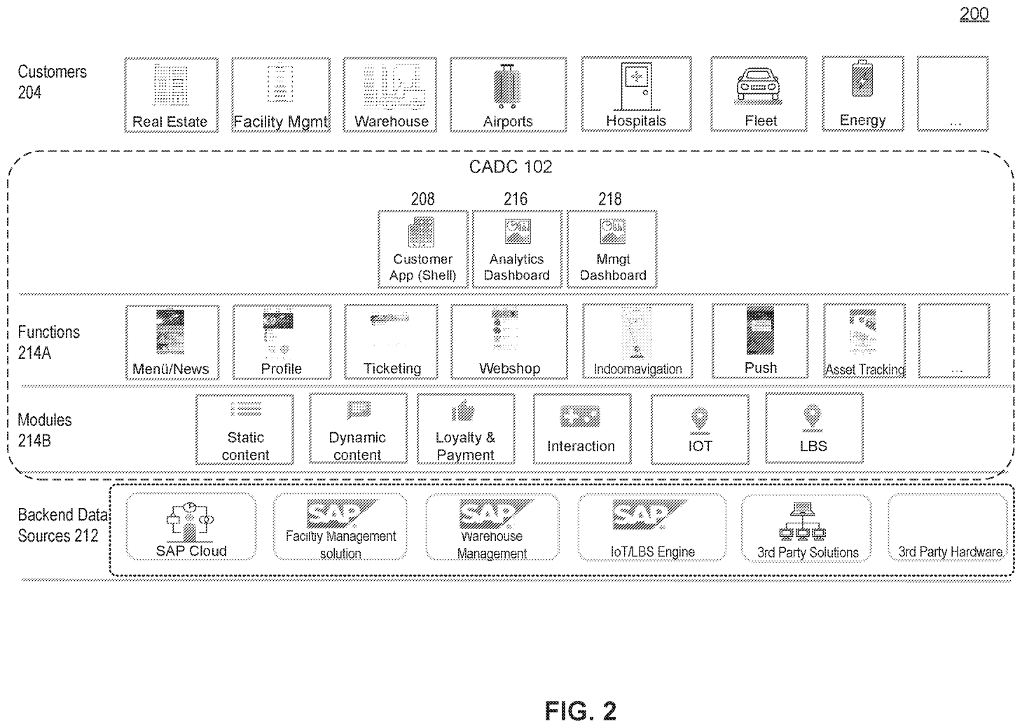

FIG. 2 is a block diagram 200 illustrating example functionality for providing a cloud-based application development and configuration system (CADC), according to some embodiments.

In the example illustrated, customers 204 may include various groups or industries which may utilize the CADC. As discussed above, one of the customers may include a sports league or teams. Other industries include hospitals, airports facilities, etc.

CADC 102 may provide a shell 208 (which is similar to shell 108), an analytics dashboard 216 and a management dashboard 218. Analytics dashboard 216 may collect and make available (to customers 204) different usage statistics about the various implementations of app shell 208. For example, customers 204 may determine how many downloads of their apps 104 are actively being used, which functions or modules 214A or 214B are being used, the active users of their apps, etc.

Management dashboard 218 may enable a customer 204 to change or update configurations 116 for their particular implementation of shell 208. In an embodiment, management dashboard 218 may also be used to update previously configured, compiled and released configurations 116. In an embodiment, when a particular configuration 116 is updated through management dashboard 216 or shell 208, the update (and not the whole app) may be pushed out or otherwise made available to the mobile devices 106A, 106B onto which a particular implementation of shell 208 has been made available or is active.

Functions 214A and modules 214B both correspond to functionality 114B of a shell 108 that may be selectable or configurable by a customer 204. A customer 204 may select or toggle which functions 214A such as ticketing, indoor navigation, etc. and which modules 214B, such as loyalty and payment programs the customer 204 wants included in the app. These may be preconfigured functionalities 114B that may require additional information from a customer for implementation.

For example, there may be three different types of loyalty programs available from which customer 204 may choose each with different options on how a user collects and uses loyalty rewards or points. The user 118A, B may then have to select which loyalty program is best suited to the user 118A, B.

Or, for example, customer 204 may choose which payment options are available via the app. Example payment options include, but are not limited to: APPLE PAY, VISA, MASTERCARD, AMERICAN EXPRESS, VENMO, SQUARE, PAYPAY, CASH ON PICKUP/DELIVERY, etc. When customer 204 selects how they desire to enable or receive payments, those selected options may, through CADC 102 and management interface 218, be made available in the particular configuration options 116 and implementation of app 104.

Customers 204 may similar select which backend data systems 212 to which the customer 204 wants to enable, disable, or maintain connectivity for its particular app 104. In an embodiment, customers 204 may also configure app to communicate with various third party systems or solutions that were not originally included in shell 208. Once all the configuration information is provided by a customer 204, and saved within a configuration profile 116, CADC 102 may generate an executable app 104.

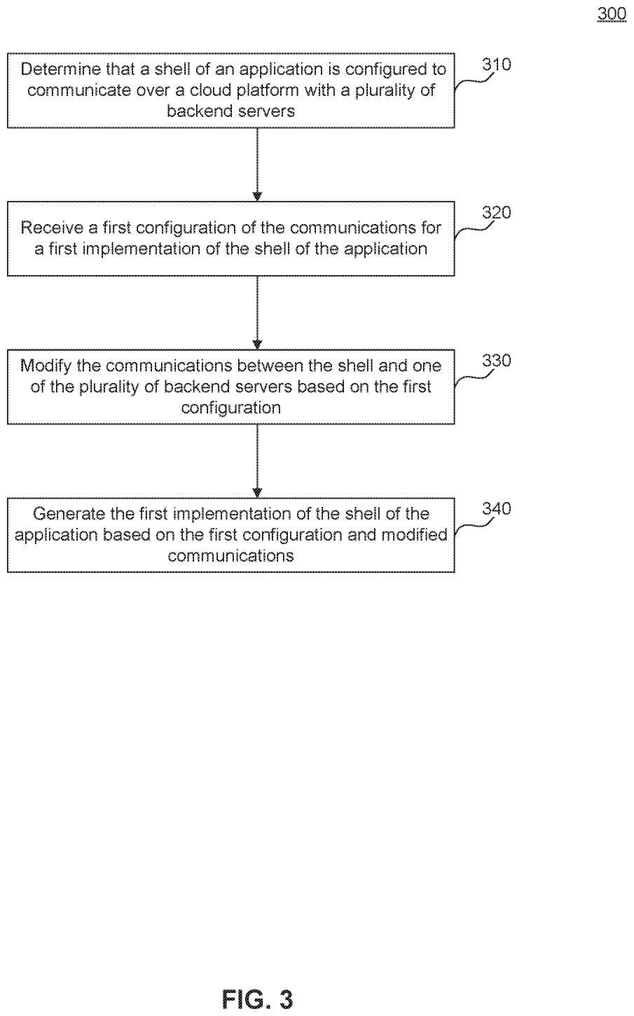

FIG. 3 is a flowchart 300 illustrating example operations of a system for providing cloud-based application development and configuration functionality, according to some embodiments. Method 300 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 3, as will be understood by a person of ordinary skill in the art. Method 300 shall be described with reference to FIG. 1. However, method 300 is not limited to the example embodiments.

In 310, it is determined that a shell of an application is configured to communicate over a cloud platform with a plurality of backend servers. For example, CADC 102 may receive a developed shell 108 that has been configured to communicate over cloud 110 with various backend servers 112A-E, any combination of which may be active or accessible in a configuration 116 or implementation of the shell 108.

In 320, a first configuration of the communications for a first implementation of the shell of the application is received. For example, an organization such as Team 1 may configure the appearance 114A, functionality 114B, and communications 114C of shell 108, which may be saved as configuration 116A. A second, different organization, such as Team 2 or an operator of a stadium or venue, may also customize shell 108 for its own purposes, and have its options stored as configuration 116B.

In 330, the communications between the shell and one of the plurality of backend servers are modified based on the first configuration. For example, when Team 1 modifies shell 108, Team 1 may provide authentication information for actually reading data from or writing data to backend system 112A, and may indicate that communications with systems 112B and 112D are not necessary. CADC 102 may toggle or modify the communications 114C accordingly and update configuration 116A.

In 340, the first implementation of the shell of the application is generated based on the first configuration and modified communications. For example, when the configurations 116A are complete, an executable version of the shell may be generated as app 104A. Shell 108 may not be an executable version of app 104A. For example, shell 108 may include a modifiable or configurable code base that is reused to generate or produce different configurations 116 for different versions an application for different clients, customers, or organizations. Configurations 116 may be configured or configurable into executable apps 104. App 104A may then be pushed out or otherwise made available to users 118 to download onto mobile devices 106A. During execution, app 104A may communicate to the configured backend systems 112 over cloud 110.

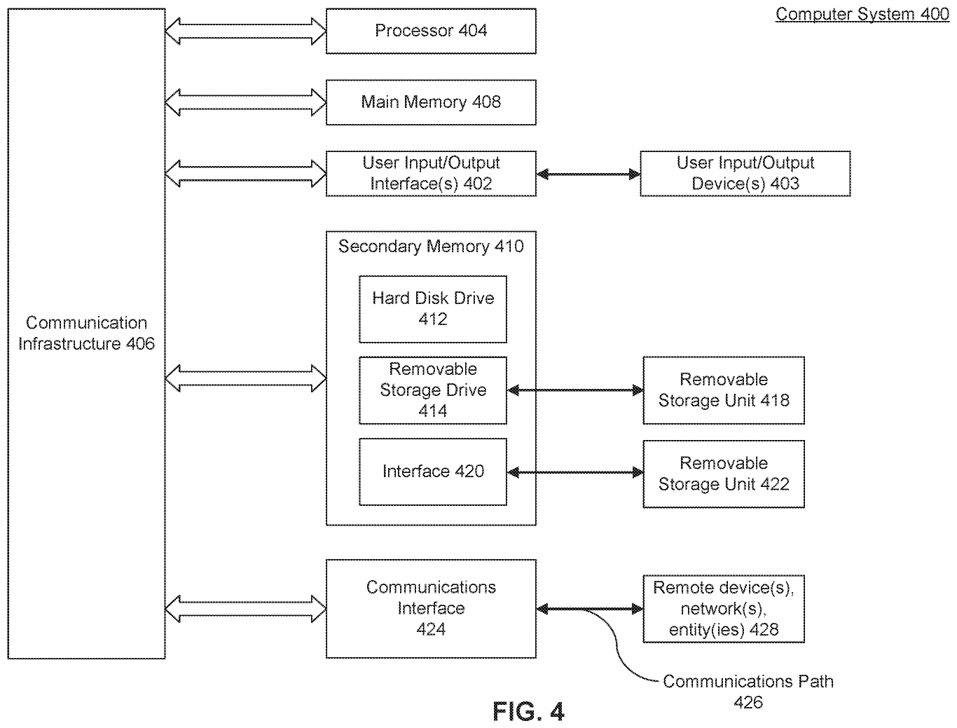

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include customer input/output device(s) 403, such as monitors, keyboards, pointing devices, etc., which may communicate with communication infrastructure 406 through customer input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
determining that a shell of an application is configured to communicate over a cloud platform with a plurality of backend servers;
receiving a first configuration of communications for a first implementation of the shell of the application, wherein the first configuration is different from a second configuration for a second implementation of the shell of the application;
modifying the communications between the shell of the application and one of the plurality of backend servers based on the first configuration; and
generating the first implementation of the shell of the application based on the first configuration and modified communications, wherein the generated first implementation is operable on a mobile device.

2. The method of claim 1, wherein at least one of the backend servers is configured to communicate with both the first implementation of the shell of the application and the second implementation of the shell of the application simultaneously.

3. The method of claim 1, wherein the first configuration includes functionality different from the second configuration.

4. The method of claim 1, wherein two or more of the backend servers correspond to two or more entities that are members of an organization.

5. The method of claim 4, wherein the organization corresponds to a physical venue.

6. The method of claim 1, wherein the first configuration includes at least one of a logo or color scheme, and wherein the generated first implementation includes the logo or color scheme of the first configuration.

7. The method of claim 1, further comprising:
reconfiguring the communications with the shell of the application, wherein the reconfiguration is applied to both the first and second implementation.

8. A system comprising:
a memory; and
at least one processor coupled to the memory and configured to perform operations comprising:
determining that a shell of an application is configured to communicate over a cloud platform with a plurality of backend servers;
receiving a first configuration of communications for a first implementation of the shell of the application, wherein the first configuration is different from a second configuration for a second implementation of the shell of the application;
modifying the communications between the shell of the application and one of the plurality of backend servers based on the first configuration; and
generating the first implementation of the shell of the application based on the first configuration and modified communications, wherein the generated first implementation is operable on a mobile device.

9. The system of claim 8, wherein at least one of the backend servers is configured to communicate with both the first implementation of the shell of the application and the second implementation of the shell of the application simultaneously.

10. The system of claim 8, wherein the first configuration includes functionality different from the second configuration.

11. The system of claim 8, wherein two or more of the backend servers correspond to two or more entities that are members of an organization.

12. The system of claim 11, wherein the organization corresponds to a physical venue.

13. The system of claim 8, wherein the first configuration includes at least one of a logo or color scheme, and wherein the generated first implementation includes the logo or color scheme of the first configuration.

14. The system of claim 8, the operations further comprising:
reconfiguring the communications with the shell of the application, wherein the reconfiguration is applied to both the first and second implementation.

15. A non-transitory computer-readable device having instructions stored thereon that, when executed by at least one computing device, cause the at least one computing device to perform operations comprising:
determining that a shell of an application is configured to communicate over a cloud platform with a plurality of backend servers;
receiving a first configuration of communications for a first implementation of the shell of the application, wherein the first configuration is different from a second configuration for a second implementation of the shell of the application;
modifying the communications between the shell of the application and one of the plurality of backend servers based on the first configuration; and
generating the first implementation of the shell of the application based on the first configuration and modified communications, wherein the generated first implementation is operable on a mobile device.

16. The device of claim 15, wherein at least one of the backend servers is configured to communicate with both the first implementation of the shell of the application and the second implementation of the shell of the application simultaneously.

17. The device of claim 15, wherein the first configuration includes functionality different from the second configuration.

18. The device of claim 15, wherein two or more of the backend servers correspond to two or more entities that are members of an organization.

19. The device of claim 18, wherein the organization corresponds to a physical venue.

20. The device of claim 15, wherein the first configuration includes at least one of a logo or color scheme, and wherein the generated first implementation includes the logo or color scheme of the first configuration.
